(19) United States
(12) Patent Application Publication
(10) Pub. No.: US 2013/0299046 A1
(43) Pub. Date: Nov. 14, 2013

(54) METHOD AND APPARATUS FOR HANDLING A TREE

(71) Applicant: Mauri Helenius, Helsinki (FI)

(72) Inventor: Mauri Helenius, Helsinki (FI)

(73) Assignee: MECLIMB OY, Helsinki (FI)

(21) Appl. No.: 13/977,091

(22) PCT Filed: Dec. 21, 2011
(86) PCT No.: PCT/FI11/51146

§ 371 Date: Aug. 2, 2013

(30) Foreign Application Priority Data
Dec. 30, 2010 (FI) 20106389

(51) Int. Cl. A01G 23/095; A01G 3/08

(52) U.S. Cl. CPC A01G 23/095; A01G 3/08
USPC 144/343; 144/3.1

(57) ABSTRACT

The object of the invention is a method and an apparatus for cutting a tree. In the method a delimbing & crosscut device cutting branches and able to cut the trunk of a tree is controlled upwards along the trunk of a tree intended to be removed and when it ascends to cut the branches of the tree that are in its way. The delimbing & crosscut device is controlled to ascend and descend along the trunk of the tree step-by-step by alternately increasing and shortening the length of the delimbing & crosscut device.

The object of the invention is a method as defined in the preamble of claim 1 and an apparatus as defined in the preamble of claim 8 for handling a tree.

The solution according to the invention is particularly well suited to removing trees causing a nuisance, such as e.g. to delimbing trees that have fallen onto electric lines and to truncating and removing trees from on top of powered electric lines. The solution according to the invention is also suited to the preventive maintenance, servicing and upkeep of the corridors of electric lines, such as to e.g. preventive clearing, in which trees that are above a powered electric line, too close to an electric line, possibly causing a disruption in electricity distribution, are removed using safe working methods. The invention is also well suited e.g. to the removal of trees growing in residential areas or in other cramped places. In addition, the solution according to the invention can be utilized also for the servicing and disassembly of electric lines e.g. such that the apparatus according to the invention climbs an electric pillar instead of a tree and disassembles the electric lines supported on the pillar.

Trees can fall onto electric lines e.g. during violent storms or also from the weight of a snow load. Trees that have fallen onto powered electric lines have, according to prior art, been removed such that the current is disconnected from the electric lines of the damaged section by isolating the electric line from the mains grid and, in addition, the damaged section of the electric line is also earthed. Earthing must be performed because, among other reasons, even though the damaged section was isolated from the mains grid, some small power station that is connected to the electric line can still supply current to the electric line. Isolating the damaged section from the mains grid and earthing it is a very laborious and time-consuming procedure, so that it is sometimes left undone. In this case, however, the people participating in repairing the damaged section are placed in life-threatening danger, because an electric shock received from a powered electric line is potentially lethal. After isolating the damaged section of the electric line from the mains grid and earthing it, a group of lumberjacks go and remove the tree by hand with the aid of motorized saws, delimbing shears and possibly other special tools. One problem, among others, in this type of conventional solution is that when disconnecting the current from powered electric lines, many households and farms, and other institutions that need electricity, are left without electricity. Disconnection of the current can cause an electricity outage to thousands of these types of locations. Electricity outages cause costs for electricity companies and trouble as well as costs and safety risks for people and, more particularly in agriculture, for animals. Another problem in the aforementioned conventional method is that the work is extremely dangerous for other reasons than the possibility of electric shock and in the work accidents can easily happen to the lumberjacks who remove trees that have fallen onto electric lines.

It is known in the art that trees growing in residential areas and in other cramped places are felled e.g. such that the person performing the felling climbs the tree and cuts the tree in stages starting from the top. A problem in this solution is, however, that the work is rather slow and also extremely dangerous. In addition, generally a second person is needed, who assists the person in the tree and guides the cut branches and pieces of trunk safely onto the ground. Finnish patent number FI115501 (B), which corresponds to U.S. Pat. No. 7,591,292 (B2), presents a delimbing apparatus and a method for delimbing erect trees. The solution comprises a frame part to be fixed to the end of an articulated boom of a power tool, such as of a forestry machine, and a separate delimbing head connected to the frame part, which delimbing head ascends along the trunk of a tree and delimbs the tree and also, if necessary, cuts the trunk starting from the top. The apparatus, with its gear wheels and accordion-type tightening device, is extremely complex and, owing to its many parts, also susceptible to failure. Another problem is that the cut branches and parts of the trunk can fall directly onto the frame part around the trunk of the tree below and can damage it. The publication also does not mention anything about removing trees that have fallen on top of electric lines. This is understandable because the apparatus is not at all suited to this type of work. The frame part and the delimbing head can only be put around the trunk of a vertical tree, not around a fallen and inclined trunk. The Finnish patent only mentions with regard to the fixing of the frame part to the boom system of a forestry machine that the frame part is fixed to the boom system with a swivel joint that allows the frame part to be turned in the desired direction, which makes it easier to delimb trees standing close by each other side by side and one behind the other. No mention is made of inclination. In addition, the patent does not present a solution with which a fallen tree can be pulled upright.

German patent publication no. DE3702760 (A1) also presents a delimbing and debarking device that ascends an erect tree. The part of the device ascending the tree comprises motor-controlled means of the caterpillar-track type, which means rest on the surface of the tree and when moving simultaneously move the delimbing head in the vertical direction. Also this publication does not mention anything about removing trees that have fallen on top of electric lines, and also this device is not even suited to such work. In addition, also this publication does not present a solution with which a tree that has fallen onto electric lines could be pulled upright.

One aim of the present invention is to eliminate the aforementioned drawbacks and also to achieve an inexpensive, simple, fast and safe method and apparatus for handling tree. In addition, an aim of the invention is to achieve a method and an apparatus, by the aid of which trees that have fallen onto electric lines or into otherwise awkward places, as well as trees standing in cramped locations, can be delimbed, cut and removed easily and safely. The method according to the invention is characterized by what is presented in the characterization part of claim 1. Correspondingly, the appliance according to the invention is characterized by what is disclosed in the characterization part of claim 8. Other embodiments of the invention are characterized by what is disclosed in the other claims.

One advantage of the solution according to the invention is that by means of it trees that have fallen onto electric lines can be removed without disconnecting the current from powered electric lines. Another advantage also is that the method is safe, because the work can be done by remote control, in which case people do not need to be too close to an electric line. Another advantage is that a tree that has fallen onto electric lines can be lifted off the lines before cutting the tree, in which case the lines are not damaged in connection with removal of the tree, and also the tree no longer conducts electricity to earth. Yet another advantage is that the apparatus according to the invention is light, as a result of which it can, if necessary, be taken to a location by hand by carrying it, in which case also trees causing a nuisance in awkward locations can be removed. Another advantage is also that by means of the method and apparatus according to the invention trees growing in residential areas or in other cramped locations can be quickly and safely removed.

In the following the invention will be described in more detail by the aid of one example of its embodiment with reference to the attached drawings, wherein

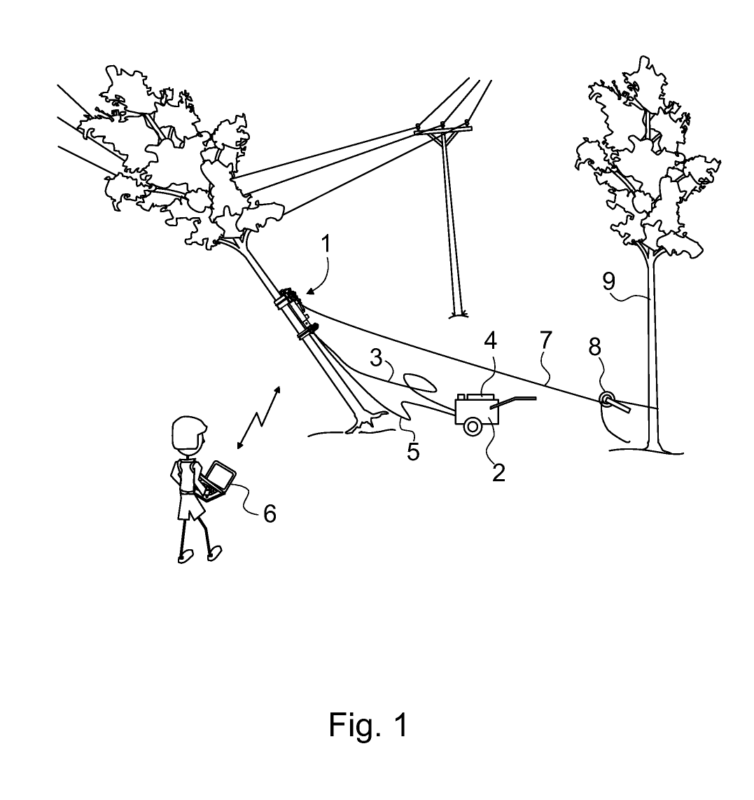

FIG. 1 presents a situation in which a tree that has fallen onto electric lines is removed with the method and apparatus according to the invention,

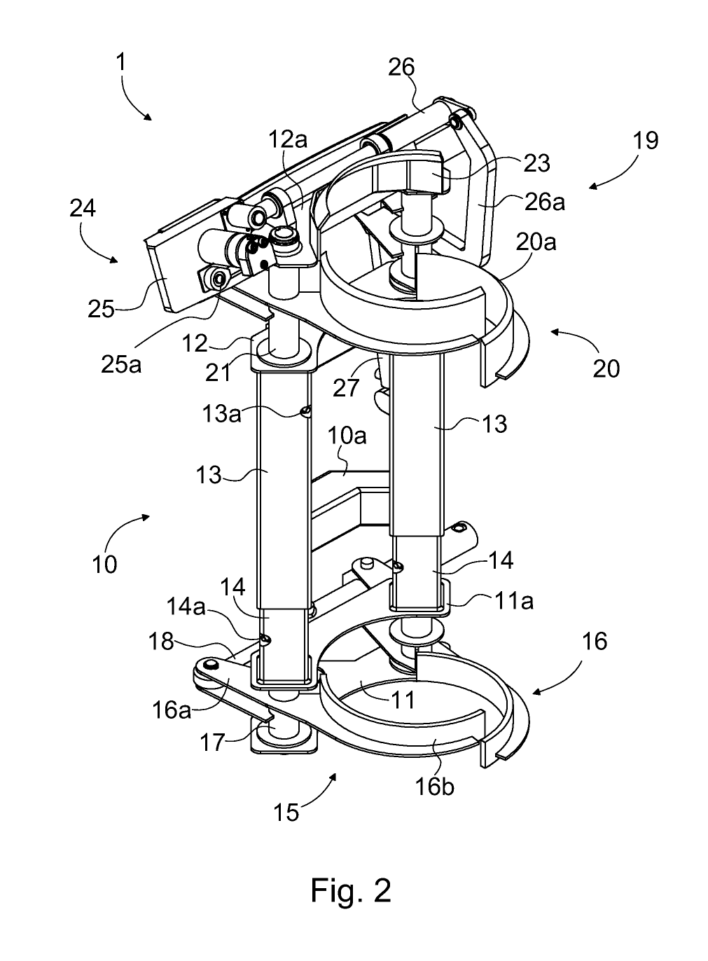

FIG. 2 presents a tree-climbing apparatus according to the invention as viewed obliquely from the side and from above,

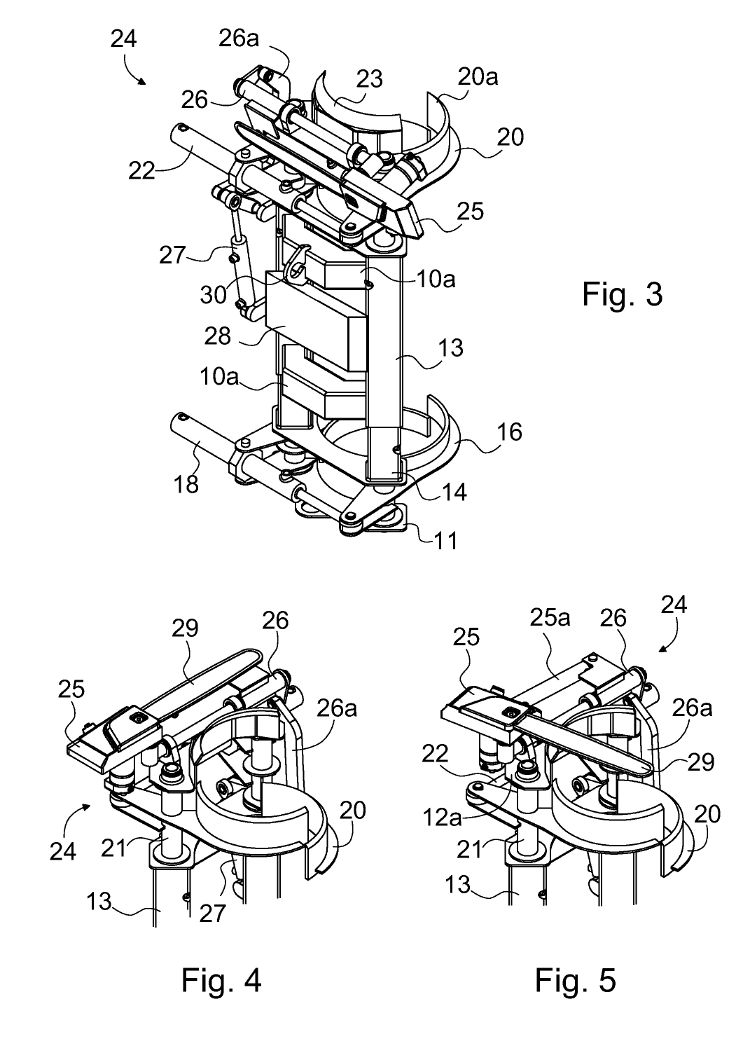

FIG. 3 presents a tree-climbing apparatus according to the invention as viewed obliquely from the rear and from above,

FIG. 4 presents the top part of a tree-climbing apparatus according to the invention as viewed obliquely from the side and from above, with the crosscut saw in one position,

FIG. 5 presents the top part of a tree-climbing apparatus according to the invention as viewed obliquely from the side and from above, with the crosscut saw in a second position,

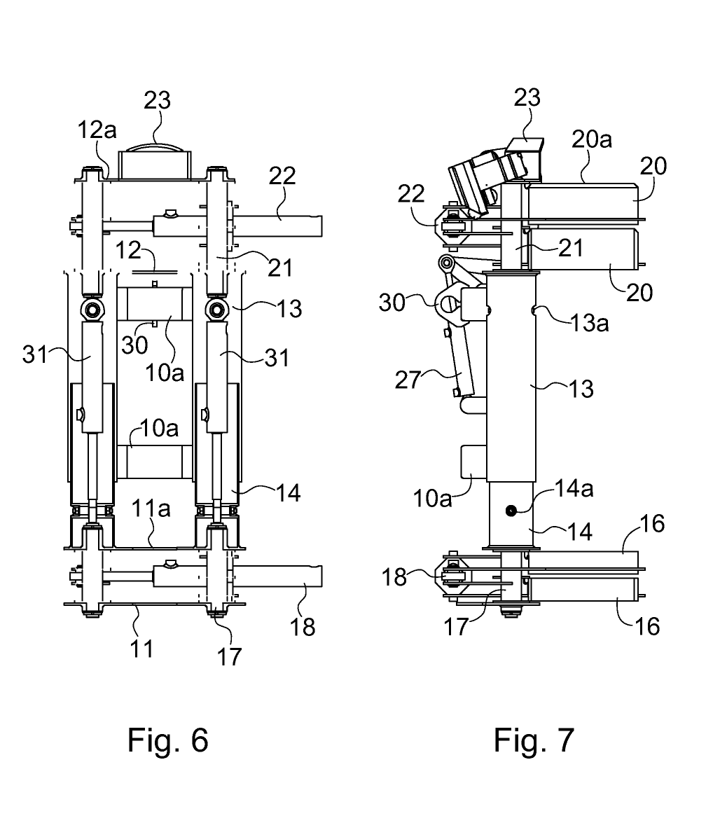

FIG. 6 presents a partially sectioned front view of a tree-climbing apparatus according to the invention,

FIG. 7 presents a side view of a tree-climbing apparatus according to the invention,

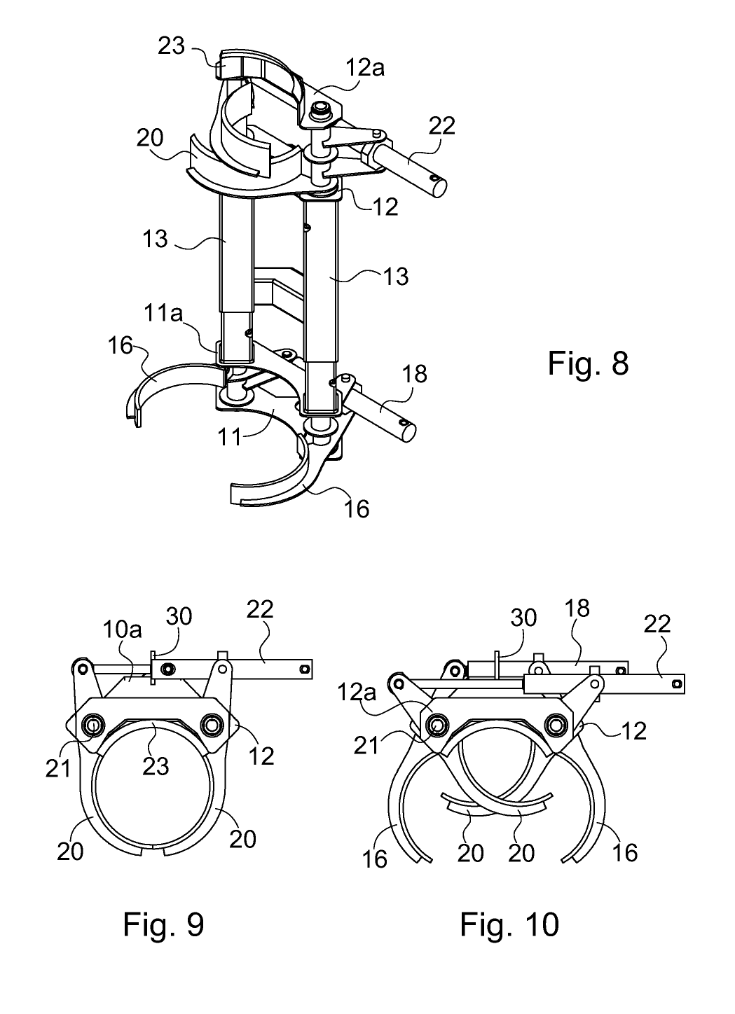

FIG. 8 presents a tree-climbing apparatus according to the invention as viewed obliquely from the side and from the front, in the ascending phase or descending phase,

FIG. 9 presents a top view of a tree-climbing apparatus according to the invention, in one position,

FIG. 10 presents a top view of a tree-climbing apparatus according to the invention, in the position according to FIG. 8, and

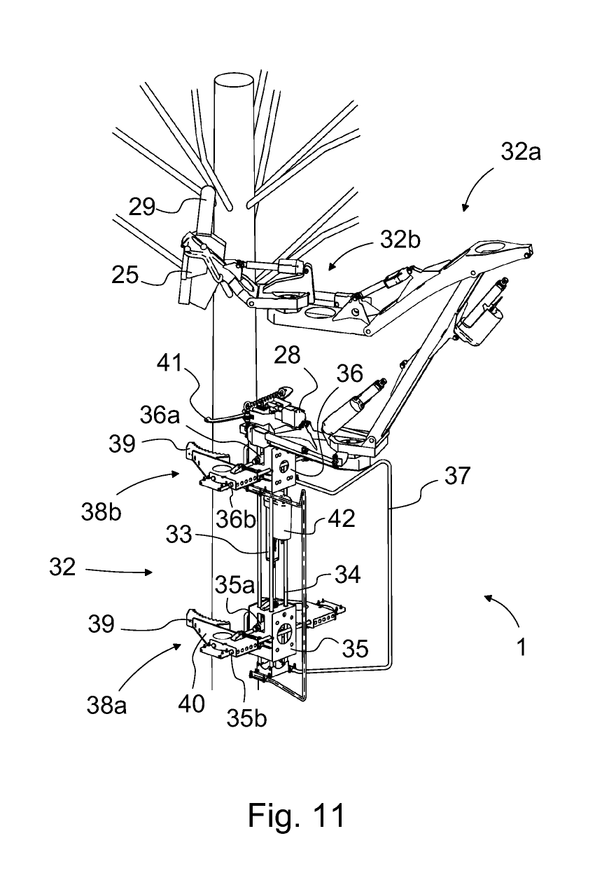

FIG. 11 presents a second preferred embodiment of a tree-climbing apparatus according to the invention as viewed obliquely from the side and from above.

FIG. 1 presents a situation in which a tree has fallen onto electric lines and it is being removed by the aid of the method and apparatus according to the invention. A delimbing & crosscut device 1 according to the invention is fitted around the trunk of the tree that has fallen on the lines, which delimbing & crosscut device is arranged to ascend along the trunk of the tree and as it ascends to cut off the branches of the tree that are in its way and finally, if necessary, the trunk of the tree at a suitable point, and as it descends also, if necessary, to cut the trunk of the tree at suitable points. In the following the shorter designation “crosscut device 1” is used to denote the delimbing crosscut device 1. In the situation according to FIG. 1, the crosscut device 1 is climbing up along the trunk of a tree that has fallen on top of electric lines. The crosscut device 1 is fitted around the trunk of the tree either by manpower or with a special remote-controlled transport device, which is not presented in the figures. The remote-controlled transport device means that the current does not need to be disconnected from the electric line for removing the tree, because people can be at a safe distance from the electric line all the time. The transport device to be remotely controlled comprises, in addition to other actuators, working lights and a video camera, which enable accurate placement of the crosscut device 1 by the aid of remote control into the correct position on the trunk of the tree in all conditions.

The crosscut device 1 is connected to a hydraulic powerpack 2 via hydraulic hoses 3. In addition, a current source 4, such as e.g. a generator and/or battery pack, is fitted in connection with the hydraulic powerpack 2, which current source 4 is connected with electric cables 5 to the crosscut device 1. The parts of the crosscut device 1 needing electricity along the electric cables 5, such as the control system, the working lights and a possible video camera, receive the necessary control current and operating current from the current source 4. The transport device and the crosscut device 1 are controlled by remote control with a control unit 6 belonging to the arrangement. The construction and the different parts of the crosscut device 1 are presented in more detail in the figures below.

The crosscut device 1 comprises a fixing point, to which a steel rope 7 or corresponding rope acting as a pulling rope is connected, which rope the crosscut device 1 takes along with it upwards along the trunk. When the crosscut device 1 has climbed to high enough, the crosscut device 1 is firmly locked around the trunk of the tree and the tree is pulled by means of the rope 7 and some suitable pulling device, such as a block and tackle 8, upright and off the electric line. The rope 7 is not in this case detached from the fixing point, such as from the pulling lug or pulling hook, on the crosscut device. During the pulling the block and tackle 8 is fixed e.g. to a growing tree 9 that will withstand the stress caused by the pulling. After this the top part of the trunk of the tree to be removed is cut off by means of the chain saw comprised in the crosscut device 1. If necessary, the crosscut device 1 cuts the trunk of the tree into parts of suitable dimension as it descends, but the final felling and truncating can also be performed later.

The portable control unit 6 comprises at least a radio unit provided with a radio transmitter, and controllers with which the functions of the crosscut device 1, of the transport device and of the hydraulic powerpack 2 are controlled by remote control. In addition, the control unit 6 comprises a display, from which a user of the control unit 6 can monitor, inter alia, the video image filmed by the video cameras on the transport device and on the crosscut device 1. By monitoring the image of the video camera of the transport device, a user of the control unit 6 is able to control the crosscut device 1 to the tree by the aid of the transport device and to fix the crosscut device 1 to the trunk of the tree by remote control. By monitoring the image of the camera of the crosscut device 1, it is possible in turn to monitor the progress of the crosscut device on the trunk of a tree.

FIG. 2 presents one tree-climbing crosscut device 1 according to the invention. The device 1 comprises at least a frame 10 comprising transverse rear supports 10a, lower supports 11 and 11a, and also upper supports 12 and 12a. In addition, the frame 10 comprises two parallel vertical supports, which comprise as a lower part cylindrical support arms 17 forming a hinge shaft for the lower grippers 16, telescopic support arms 13 and 14 as an extension of said support arms 17 upwards, and second cylindrical support arms 21 as a further extension of said support arms 17 upwards, which support arms 21 at the same time form a hinge shaft for the upper grippers 20. The transverse supports 10a-12a together with the vertical supports 13, 14, 17 and 21 form a frame 10 supporting the crosscut device 1, the distance of the top part 19 of which frame from the bottom part 15 can be changed by means of the telescopic support arms 13 and 14, the combined length of which is controlled by means of position sensors 13a and 14a.

The lower grippers 16 are hinged on the lower cylindrical support arms 17, which lower grippers consist of at least a hinge arm 16a pointing backwards from the crosscut device 1 and of an inward curving gripper arm 16b pointing forwards from the crosscut device 1, which gripper arm is pressed around the trunk of the tree. There are two lower grippers 16 opposite each other but at a different height with respect to each other in relation to the frame 10 such that in the closed position the gripper arms 16b opposite each other overlap as viewed from above in relation to each other. A power means 18, such as a hydraulic cylinder, achieving a linear movement connects the hinge arms 16a of the lower grippers 16, which power means is fitted by means of a remote-controlled control unit 6 to move the curved gripper arms 16b of the grippers 16 towards each other and away from each other, i.e. at the same time to close and to open the curved gripper arms 16b forming a space.

Correspondingly, the upper grippers 20 are hinged on the upper cylindrical support arms 21, which grippers are essentially similar in their shape, structure and articulation to the lower grippers 16. A power means 22, which is not visible in FIG. 2, achieving a linear movement connects the hinge arms of the upper grippers 20. The power means 22 is e.g. a hydraulic cylinder, which is fitted by means of a remote-controlled control unit 6 to move the curved gripper arms of the grippers towards each other and away from each other in the same manner as the power means 18 moves the gripper arms 16b of the lower grippers 16.

The top edge of the curved gripper arms of the upper grippers 20 contains a shearing blade 20a, by means of which the crosscut device 1 cuts off branches of a tree that are in its way when it climbs upwards. In addition, the top part of the crosscut device 1 comprises a third curved cutting blade 23, the top edge of which comprises a similar shearing blade as in the top edge of the curved gripper arms of the grippers 20. The cutting blade 23 is fixed e.g. to the transverse top support 12a of the frame 10 in such a position that together with the shearing blades 20a of the gripper arms 20 the shearing blade of the cutting blade 23 forms an essentially at least full circle around the trunk of a tree, in which case the shearing blades of the tree are able to cut off branches of the tree leaving in all directions when the crosscut device 1 climbs upwards along the tree.

The top part of the crosscut device 1 further comprises an articulated crosscut unit 24, which comprises at least a hydraulic saw 25, such as a chainsaw, acting as a crosscut means, and actuators, such as hydraulic cylinders 25a and 27 as well as a rotating shaft 26 and lever arm 26a, turning the chainsaw 25 into the transport position and into various sawing positions. The crosscut unit 24 is intended for cutting the trunk of the tree, but if necessary also thicker branches can be cut with it.

FIG. 3 presents an oblique rear view of a tree-climbing crosscut device 1 according to FIG. 2. FIG. 3 presents some parts that are not presented in FIG. 2. One such part is the control cubicle 28, which is not presented in the other figures, that is attached to the frame 10 on the rear side of the crosscut device 1. Most of the components, such as hydraulic valves and other control logic as well as the necessary electronics, such as the remote control receiver, et cetera, needed for the control and operation of the crosscut device 1 are assembled into the protection of the control cubicle 28. The hydraulic hoses 3 and electric cables 5 between the hydraulic power pack 2 and the crosscut device 1 are fixed first to the frame 10 of the crosscut device 1 to a supporting point and led from there without tension to the control cubicle 28. The fixing points and the hydraulic connectors are not shown in the figures.

In addition, at the rear of the crosscut device 1 is a pulling lug 30 or corresponding fixed to a supportive point, e.g. to the upper transverse rear support 10a, to which pulling lug the steel rope 7 functioning as a pulling rope is fixed for taking an end of the rope up into the tree for pulling the tree upright when the crosscut device 1 has finished the tree ready for lifting upright.

FIGS. 4 and 5 present the top part of one crosscut device 1 according to the invention with the crosscut unit 24. In FIG. 4 the chainsaw 25 is ready for cutting the trunk of the tree. In this case the chainsaw 25 is turned by means of the hydraulic cylinder 27 from the transport position into the sawing position, in which the blade 29 of the chainsaw 25 is transverse with respect to the trunk of the tree. Correspondingly, in FIG. 5 the blade 29 of the chainsaw 25 is in a position in which the trunk of the tree has been sawn through. In this case the hydraulic cylinder 25a has turned the blade 29 on a transverse plane with respect to the trunk of the tree. The sawing function can also be performed in a spring-loaded manner, in which case the hydraulic cylinder 25a is only needed for turning the saw 25 back into its initial position after the sawing.

In FIG. 6 the crosscut device 1 according to the invention is presented as viewed from the front, and partially sectioned and partially simplified. Inside each telescopic support arm and 14 is a hydraulic cylinder 31 achieving a linear movement as an actuator, the piston rod at the first end of which cylinder is fixed to cylindrical support arms 17 in the bottom part of the crosscut device 1 and the cylinder part at the second end of which cylinder is fixed to cylindrical support arms 21 in the top part of the crosscut device 1. Thus the distance between the top part 19 and the bottom part 15 of the crosscut device 1 and at the same time the distance between the upper grippers 20 and the lower grippers 16 can be changed. By increasing the length of the hydraulic cylinder 31 functioning as a power means, the distance of the upper grippers 20 from the lower grippers 16 is at the same time increased, and by shortening the length of the cylinder the distance of the upper grippers 20 from the lower grippers 16 is at the same time decreased. In this way a stepped movement in the direction of the trunk of the tree is obtained, by means of which movement the crosscut device 1 changes its length in steps and climbs the tree and also descends from the tree. Instead of the two hydraulic cylinders 31 presented, the device can also comprise only just one hydraulic cylinder bringing about a linear movement, e.g. on the center line of the device.

FIG. 7 the crosscut device 1 according to the invention is presented as viewed from the side, and partially sectioned and partially simplified. In FIG. 7 it is clearly seen how, with respect to the longitudinal direction of the frame 10, the lower grippers 16 are at different points to each other and the upper grippers 20 are at different points to each other. In this way the grippers can overlap in relation to each other.

In FIGS. 8-10, the crosscut device 1 according to the invention is presented when partly simplified both in the climbing position and firmly fixed to the trunk of a tree e.g. for pulling the tree into a vertical position. FIGS. 8 and 10 present a climbing situation, in which the crosscut device 1 has been locked by the aid of its upper grippers 20 to the trunk of a thin tree and has loosened the grip of the lower grippers 16 on the trunk of the tree. In this situation the lower grippers 16 can be moved along the trunk of the tree either upwards or downwards depending on the situation. Correspondingly, in the situation according to FIG. 9 the crosscut device 1 has locked both the upper and the lower grippers around a medium-sized tree. In this case the crosscut device 1 stays firmly in place and a tree that has fallen onto electric lines can be e.g. pulled upright.

All the hydraulic actuators presented above, or at least a part of them, can also be electrically-operated actuators, such as e.g. spindle motors, and instead of a hydraulic powerpack 2 and/or current source 4 on the ground the crosscut device 1 can be provided with its own chargeable current source giving current to all the actuators of the crosscut device 1, such as with one or more accumulators, which are fixed in connection with the crosscut device 1 to travel along with the crosscut device 1 into a tree. In this way the crosscut device 1 can operate under remote control as a wireless and hoseless unit.

FIG. 11 presents a second preferred tree-climbing and extremely lightweight apparatus according to the invention. In this embodiment, the lightweight crosscut device 1 according to the invention is presented as viewed from the rear and partially simplified.

The crosscut device 1 comprises at least a frame 32 comprising a bottom part 35 and a top part 36 as well as, between the top part and the bottom part, guides 34 in the direction of the climbing movement and descending movement. In addition, the crosscut device 1 comprises a spindle motor functioning as a power means 33, by the aid of which the distance between the bottom part 35 and the top part 36 can be changed in the climbing phase and descending phase forming the stepped, i.e. cyclical, movement of the crosscut device 1 in essentially the same manner as has already been explained. The distance between the bottom part and top part is controlled in the climbing phase and descending phase e.g. by means of position sensors suited to the purpose. The climbing movement and descending movement are essentially similar to what has been described above.

Carrying handles 37 are also fixed to the frame 32 of the crosscut device 1, by means of which handles the lightweight-structured device can be transported by carrying, and an articulated, multiple-part boom structure 32a, which functions in the manner of a robot arm. At the free end of the boom structure 32a is a mounting base 32b for the tools, such as a chainsaw 25 or some other necessary tool, such as a nut opener, metal cutting tool or corresponding, to be used with the crosscut device 1. In addition, the top part of the crosscut device 1 comprises locking means 41, such as grapple tongs, by means of which the crosscut device 1 can be firmly fixed to the tree to be handled e.g. for pulling the tree upright by means of a rope 7 and a pulling device 8. The grapple tongs 41 operate by the aid of an actuator, e.g. a spindle motor, intended for them and there are preferably means, such as a fastening ring or a pulling hook or corresponding, in connection with the grapple tongs 41 for fixing a rope 7 to the crosscut device 1.

The bottom part 35 of the crosscut device 1 comprises two gripper arms 38a that are essentially similar to each other but that move in an opposite direction to each other and the top part 36 correspondingly comprises two gripper arms 38b that are essentially similar to each other but that move in an opposite direction to each other for enabling the climbing movement and descending movement of the crosscut device 1. All the gripper arms 38a and 38b comprise a supporting stem part 40, which is fitted to the guides 35b, 36b in the bottom part and in the top part, which guides are disposed at an essentially orthogonal direction to the direction of the climbing movement and descending movement of the crosscut device 1, i.e. in practice often horizontal. The bottom part 35 of the frame 32 comprises a spindle motor functioning as an actuator 35a for moving the gripper arms 38a towards each other and the top part 36 of the frame 32 comprises a spindle motor functioning as an actuator 36a for moving the gripper arms 38b towards each other. At the free end of the gripper arms 38a, 38b is a gripper 39, the inside surface of which is curved and roughened so that the grip of the gripper 39 on the tree or pillar would be as firm as possible.

The crosscut device 1 according to FIG. 11 preferably comprises its own rechargeable current source 42, such as e.g. a battery pack consisting of one or more batteries, by the aid of which the crosscut device 1 climbs a tree and descends from a tree and also performs under remote control all the necessary procedures described above. The current source 42 can e.g. be separately, carried to the worksite and can be easily and quickly fixed to the crosscut device 1. Instead of, or in addition to, its own current source 42, the crosscut device 1 can also be provided with a ground-based hydraulic powerpack 2 and/or current source 4. In this case the actuators of the crosscut device 1, such as the aforementioned spindle motors, or at least some of the aforementioned actuators can also be hydraulic.

The crosscut device 1 according to FIG. 11 comprises an essentially similar control cubicle 28 as what has been described above and the crosscut device 1 can be controlled by means of an essentially similar remote-controlled control unit 6, as has been described earlier. The control cubicle 28 comprises e.g. a logic & radio unit, by the aid of which all control commands are given wirelessly. Also, however, wireline control can be used. In addition, the crosscut device 1 comprises a wireless or wireline video camera and working light, which are operated as already described above.

The crosscut device 1 according to FIG. 11 has the advantage with respect to the crosscut device mentioned previously that the structure contains no hinges via which movement of an actuator is transmitted to the grippers 39 for gripping to a tree or pillar.

In the crosscut device 1 according to FIG. 11, pressing of the gripper parts 39 against the trunk of a tree and detachment of them from the trunk of the tree is performed with an essentially linear movement. In this case e.g. for moving the lower gripper parts 39 towards the trunk of the tree, the grippers 38a opposite each other, with their gripper arms 40, are pulled linearly towards the trunk of the tree with the spindle motor 35a functioning as an actuator while guided by the linear guides 35b, until the gripper parts 39 are firmly pressed against the trunk of the tree and their grip on the tree is sufficiently durable. Correspondingly, detachment of the gripper parts 39 from the trunk of the tree is performed with an opposite linear movement by means of the spindle motor 35a. The upper grippers 38b with their gripper parts 39 and stem parts 40 are correspondingly moved linearly with the spindle motor 36a guided by the guides 36b.

With the method according to the invention a tree causing a nuisance is removed e.g. as follows: the crosscut device 1 is brought to the tree to be removed either by carrying with manpower or with a transport device suited to the purpose and is placed around the trunk of the tree from the side of the trunk by pushing the crosscut device 1 with the grippers 16, 20, 39 to the front, when the grippers 16, 20, 39 are in the open position, onto the trunk of the tree and after this by locking at least the lower grippers 16, 39 around the trunk of the tree. After this a command to climb the tree is given with the remote controller 6 to the crosscut device 1, in which case the crosscut device 1 climbs the tree according to a defined control logic and operating logic such that at first the upper grippers 20, 39 are loosened from around the trunk of the tree, if they were earlier locked around the trunk.

After this the length of the frame 10, 32 of the crosscut device is increased by means of the telescopic support arms 13 and 14 as well as by means of the hydraulic cylinders 31 or the spindle motor 33 acting as the power means, in which case the distance between the upper grippers 20, 39 and the lower grippers 16, 39 increases. When the distance is at its maximum or otherwise e.g. in the correct spot determined by the sensors 13a, 14a, the upper grippers 20, 39 are locked around the trunk of the tree and the lower grippers 16, 39 are loosened from around the trunk, after which the length of the frame 10, 32 of the crosscut device is shortened by means of the telescopic support arms 13 and 14 as well as by means of the hydraulic cylinders 31 or the spindle motor 33, in which case the distance between the upper grippers 20, 39 and the lower grippers 16, 39 decreases. When the distance is at its permitted minimum or otherwise e.g. in the correct spot determined by the sensors 13a, 14a, the lower grippers 20, 39 are locked around the trunk of the tree and the upper grippers 16, 39 are loosened from around the trunk, and the climbing is continued in this way step-by-step and at the same time branches in the way are cut off by means of the shearing blades 20a and the cutting blade 23 or by means of the chainsaw 25, until the desired height is reached.

When the crosscut device 1 is at the desired height, the top of the upright tree is cut off by means of the chainsaw 25 and the top is allowed to drop to the root of the tree. After this a command is given with the remote controller 6 to the crosscut device 1 to come down from the tree and, if necessary, parts of the desired dimension are cut from the trunk of the tree with the chainsaw 25 when coming down, which parts are allowed also to drop to the root of the tree.

The procedure described above is good to use e.g. for removing trees in cramped places in residential areas. For the removal of a tree that has fallen at an inclined angle onto electric lines, it is instead good to use a slightly different method according to the invention. Placement of the crosscut device 1 around the trunk of the tree, climbing the tree and the cutting off of branches is performed in the same way as described earlier. The difference is now that for pulling the tree upright a steel rope 7, or corresponding rope, is fixed to the pulling hook 30 on the crosscut device when the crosscut device 1 is still at the bottom, the free end of which rope is connected e.g. to a block and tackle 8, which is further fixed to some supporting point, e.g. to a growing and sufficiently strong tree 9. The crosscut device 1 when it climbs takes the rope 7 into the tree and when the crosscut device 1 has ascended to the desired height, the tree that has fallen at an angle onto an electric line is pulled upright by means of the block and tackle 8 and the rope 7, after which the top of the tree is cut off by means of the chainsaw 25. After this the crosscut device 1 is ordered down, as stated earlier. If so desired, the trunk of the tree is cut in connection with the descent into shorter parts.

In the method the crosscut device 1 is controlled by means of the remote-control device 6 using as an aid the video image of a video camera on the crosscut device 1 and, if necessary, a working light, as explained above.

It is obvious to the person skilled in the art that the invention is not limited solely to the example described above, but that it may be varied within the scope of the claims presented below. Thus, for example, the phases of the method can be different and in a different sequence to what is presented above.

It is further obvious to the person skilled in the art that the apparatus can be structurally different to what is described above.

It is also obvious to the person skilled in the art that the apparatus can be configured to climb along all pillar-like structures and not just along trees. Thus, for example, the apparatus can be configured to climb along e.g. electric pillars or lighting pillars or e.g. along various beam structures, and the apparatus can take along with it various tools for various procedures to be performed on a pillar.

1. A method for handling a tree, in which method a delimbing & crosscut device cutting branches and able to cut the trunk of a tree is controlled by means of remote control transmitted by a remote-control unit upwards along the trunk of the tree intended to be removed either step-by-step by alternately increasing and shortening the length of the delimbing & crosscut device or moved by at least one roller-type traction means, and when it ascends to cut the branches of the tree that are in its way, and which delimbing & crosscut device is controlled by means of remote control transmitted by the remote-control unit to descend along the trunk of the tree step-by-step by alternately increasing and shortening the length of the delimbing & crosscut device or moved by at least one roller-type traction means, wherein in connection with the removal of a tree that is in an inclined position, such as a tree that has fallen onto an electric line, a pulling rope is fixed to the delimbing & crosscut device for pulling said rope up into the tree, by means of which pulling rope the tree is pulled upright or off the electric line.

2. The method according to claim 1, wherein the trunk of the tree to be removed is gripped alternately with the grippers on the bottom part of the delimbing & crosscut device and the grippers on the top part of the delimbing & crosscut device, and in that the grippers on the bottom part and the grippers on the top part are shifted in the ascending phase alternately upwards in the direction of the trunk of the tree and downwards in the descending phase.

3. The method according to claim 1 or 2, wherein in the ascending phase the movement of the grippers in the direction of the trunk of the tree is implemented with one or more power means, such as with a hydraulic cylinder or spindle motor, the length of which is increased when the lower grippers are locked around the trunk of the tree and the upper grippers are detached from the trunk of the tree, and the length of which power means is shortened when the upper grippers are locked around the trunk of the tree and the lower grippers are detached from the trunk of the tree.

4. The method according to claim 1 or 2, wherein in the descending phase the movement of the grippers in the direction of the trunk of the tree is implemented with one or more power means, such as with a hydraulic cylinder or spindle motor, the length of which is increased when the upper grippers are locked around the trunk of the tree and the lower grippers are detached from the trunk of the tree, and the length of which power means is shortened when the lower grippers are locked around the trunk of the tree and the upper grippers are detached from the trunk of the tree.

5. The method according to claim 1, wherein in that pressing of the gripper parts of the crosscut device against the trunk of the tree and detachment of them from the trunk of the tree is performed with an essentially linear movement such that for moving the gripper parts towards the trunk of the tree the grippers opposite each other are pulled essentially linearly towards the trunk of the tree with the spindle motor, which is the actuator, while guided by guides, until the gripper parts are firmly pressed against the trunk of the tree and their grip on the tree is sufficiently durable, and correspondingly detachment of the gripper parts from the trunk of the tree is performed with an opposite linear movement by means of the spindle motor.

6. The method according to claim 1, wherein in connection with the removal of a tree that is in an inclined position, such as a tree that has fallen onto an electric line, a pulling rope is fixed to the delimbing & crosscut device for pulling said rope up into the tree, by means of which pulling rope the tree is pulled upright and off the electric line before the top of the tree is cut off with a cutting means, such as a chainsaw, accompanying the delimbing & crosscut device.

7. The method according to claim 1, wherein the delimbing & crosscut device is fitted around the trunk of the tree that is intended to be removed by manpower or with the transport device to be controlled with the remote-control unit, and in that the functions of the delimbing & crosscut device on the tree intended to be removed are controlled with the remote-control unit.

8. An apparatus for handling a tree, which apparatus comprises at least a delimbing & crosscut device, comprising a frame and moving means for controlling the delimbing & crosscut device up into a tree to be removed and down from the tree along the trunk, and means for cutting off branches in the way in the ascending phase as well as means for cutting the trunk of the tree to be removed, and in that the apparatus comprises grippers locking the delimbing & crosscut device around the trunk of the tree to be removed and means for changing the distance between the grippers, or at least one roller-like traction means enabling the climbing and descending of the delimbing & crosscut device, wherein the delimbing & crosscut device comprises means for fixing a pulling rope to the delimbing & crosscut device.

9. The apparatus according to claim 8, wherein the first grippers are in the bottom part of the frame of the delimbing & crosscut device and the second grippers are in the top part of the frame of the delimbing & crosscut device, and in that the length of the frame can be changed by the aid of a power means, such as one or more hydraulic cylinders or spindle motors, making a linear movement.

10. The apparatus according to claim 8 or 9, wherein the delimbing & crosscut device comprises its own current source, such as one or more rechargeable batteries, that is easily attachable to the device.

11. The apparatus according to claim 8, wherein the delimbing & crosscut device comprises guides that are in an essentially orthogonal direction with respect to the climbing movement and descending movement, on which are disposed gripper arms with gripper parts gripping the tree, said gripper arms to be moved towards the tree and away from the tree along the guides by means of actuators.

12. The apparatus according to claim 8, wherein the delimbing & crosscut device comprises locking means, such as grapple tongs, means of an actuator operating which the delimbing & crosscut device can be firmly fixed to the tree to be handled e.g. for pulling the tree upright by means of a rope and a pulling device.

13. The apparatus according to claim 8, wherein the apparatus comprises control logic for gripping the trunk of the tree to be removed alternately with the grippers on the bottom part and the grippers on the top part of the delimbing & crosscut device and for transferring the grippers on the bottom part as well as the grippers on the top part in the direction of the trunk of the tree alternately in the ascending phase upwards and in the descending phase downwards.

14. The apparatus according to claim 8, wherein the control logic comprises means, by the aid of which the control logic is arranged to implement in the ascending phase movement of the grippers in the direction of the trunk of the tree with the power means such that the length of the power means is increased linearly when the lower grippers are locked around the trunk of the tree and the upper grippers are detached from the trunk of the tree, and the length of the power means is shortened when the upper grippers are locked around the trunk of the tree and the lower grippers are detached from the trunk of the tree.

15. The apparatus according to claim 8, wherein the control logic comprises means, by the aid of which the control logic is arranged to implement in the descending phase movement of the grippers in the direction of the trunk of the tree with the power means such that the length of the power means is increased linearly when the upper grippers are locked around the trunk of the tree and the lower grippers are detached from the trunk of the tree, and the length of which power means is shortened when the lower grippers are locked around the trunk of the tree and the upper grippers are detached from the trunk of the tree.

16. The apparatus according to claim 8, wherein the delimbing & crosscut device comprises a curved cutting blade pointing upwards and curved shearing blades that point upwards and are connected to the upper grippers for cutting off in the ascending phase the branches in the way of the delimbing & crosscut device, and in that the force for cutting the branches is taken from the linear movement of the power means.

17. The apparatus according to claim 8, wherein the delimbing & crosscut device comprises an articulated, multiple-part boom structure functioning in the manner of a robot arm, at the free end of which boom structure is a mounting base for the tools, such as a chainsaw or some other necessary tool, such as a nut opener, metal cutting tool or corresponding, to be used with the delimbing & crosscut device.

18. The apparatus according to claim 8, wherein the delimbing & crosscut device comprises a remote control receiver for controlling the functions in the delimbing & crosscut device by the aid of a remote controller.
